(19) United States
(12) Patent Application Publication
(10) Pub. No.: US 2026/0034021 A1
(43) Pub. Date: Feb. 5, 2026

(54) VESSEL DILATION DEVICE FOR DISTAL BODY PARTS

(71) Applicant: Kwang Seok KIM, Gwangju (KR)

(72) Inventor: Kwang Seok KIM, Gwangju (KR)

(21) Appl. No.: 18/718,200

(22) PCT Filed: Jun. 3, 2022
(86) PCT No.: PCT/KR2022/007952

§ 371 Date: Oct. 23, 2025

(30) Foreign Application Priority Data
Dec. 13, 2021 (KR) 10-2021-0178073

(51) Int. Cl. A61H 9/00; A61H 19/00

(52) U.S. Cl. CPC A61H 9/0057; A61H 19/32; A61H 2201/1207; A61H 2201/1238; A61H 2201/1638; A61H 2201/1642; A61H 2201/1645; A61H 2201/1692

(57) ABSTRACT

The present invention relates to a vessel dilation device for distal body parts and, particularly, to a vessel dilation device for distal body parts, the device promoting the dilation of blood vessels of the distal body parts (the hands, feet or penis) during use thereof so as to make the blood flow smoothly, thereby enabling blood circulation function to be improved and physical vitality to be increased. To this end, the present invention comprises: a main body, which has, therein, a first accommodation space into which a distal body part (the hands, feet or penis) is inserted, is made from a flexible material so as to closely encompass the distal body part inserted toward a closed one side portion thereof, and has a plurality of micro cut holes formed in the side surface thereof; and a housing, which has, therein, a second accommodation space in which the main body is inserted and mounted, and has, at one end portion thereof, a suction hole to which a decompressor is separably connected, and thus is induced into a vacuum state by allowing the air of the second accommodation space to be suctioned by means of the decompressor.

### TECHNICAL FIELD

The present invention relates to a vessel dilation device for distal body parts, and more particularly, to a vessel dilation device for distal body parts, the device promoting the dilation of blood vessels of the distal body parts (hands, feet or penis) during use thereof so as to make the blood flow smoothly, thereby improving blood circulation function and increasing physical vitality.

### BACKGROUND ART

Blood vessels in a human body shrink due to aging or waste products accumulate therein as time passes, thereby causing problems in blood circulation.

In particular, blood circulation disorders become more severe toward a distal body part (hand, foot, or penis), and as a result, problems such as decreased blood circulation function and cold hands and feet occur, and overall physical vitality is inevitably decreased.

Meanwhile, due to the development of civilization and the convenience of transportation, the sexual function among the distal parts of the male body tends to be weakening, thereby causing various diseases related to the male genitals.

The diseases related to the male genitals include erectile dysfunction, Peyronie's disease, premature ejaculation, or seborrhea, and remedies for these diseases include taking drugs or supplements or applying physical procedures, surgery or the like. In order to solve the diseases related to the male genitals, including erectile dysfunction, Korean Registered Patent Publication No. 10-1119668 (Patent Document 1) previously filed by the present applicant discloses a corpus cavernosum expansion device to allow the penis to be inserted and withdrawn regardless of an erection state and enlarge a size of the glans penis.

However, despite technical improvements for achieving the above-described effects, when a vacuum is induced through a decompressor during use of the corpus cavernosum expansion device formed with a hole having a large diameter at a site in close contact with the glans penis, the glans penis may be pushed outward through the hole, thereby causing skin damage such as blisters or bleeding.

Therefore, there is a need for the development of technology for improving blood circulation disorders in the distal body parts (hands, feet, or penis).

### DISCLOSURE

### Technical Problem

The present invention is disclosed to solve the above-mentioned problem, and an object of the present invention is to provide a vessel dilation device for distal body parts to promote expansion of blood vessels in a distal body parts (hands, feet, or penis) when used, and especially to induce expansion of the blood vessels or the corpus cavernosum penis while suppressing skin damage when applied to the distal body parts (hand, foot, or penis).

### Technical Solution

The vessel dilation device for distal body parts according to the present invention for achieving the above object includes: a main body formed therein with a first accommodation space into which a distal body part (hand, foot or penis) is inserted, formed of a flexible material to tightly encompass the distal body part inserted toward a closed one side portion thereof, and formed in a side surface thereof with a plurality of micro cut holes; and a housing formed therein with a second accommodation space into which the main body is inserted and mounted, and formed at one end portion thereof with a suction hole for allowing a decompressor to be separably connected, in which air in the second accommodation space is sucked by the decompressor, thereby being induced into a vacuum state.

The main body may have a fitting cap bent along an outer circumference of the other side portion into which the distal body part is inserted, and extending to one side, in which the other end of the housing may be fitted between the outer circumferential surface of the other end of the main body and the inner circumferential surface of the fitting cap to come into close contact with each other.

The body may include: one or more annular support protrusions protruding r circumferential surface thereof to closely contact and support the distal body part inserted into the above-described first accommodation space; a plurality of stimulation protrusions protruding from the inner circumferential surface thereof, other than the above-described support protrusions, to closely contact and stimulate the distal body part inserted into the first accommodation space; and a plurality of prevention protrusions protruding from the outer circumferential surface thereof in a circumferential direction or in a direction from the one side to the other side to prevent the micro cut holes from being excessively expanded when the second accommodation space is decompressed through the decompressor.

The micro cut holes may be slightly expanded when the second accommodation space is decompressed through the decompressor.

The main body may further may include an elastic rod formed between the inner and outer circumferential surfaces of the main body to induce elasticity of the support protrusions according to injection or suction of air, and the housing may further include an insertion hole into which an air tube is inserted so as to be mounted to an inlet side of the elastic rod, and the air tube may be connected to an air pump.

### Advantageous Effects

Thus, the vessel dilation device for distal body parts according to the present invention may promote the dilation of blood vessels of the distal body parts (hands, feet or penis) during use thereof so as to make the blood flow smoothly, so that blood circulation including the distal body parts can be improved and thus body vitality can be increased.

In addition, when the dilation of blood vessels is promoted in the distal body parts (hands, feet, or penis), excessive expansion of the skin itself may be limited, so that the dilation of blood vessels or corpus cavernosum penis can be induced while suppressing skin damage.

### DESCRIPTION OF DRAWINGS

FIG. 1 is a perspective view schematically showing a vessel dilation device for distal body parts according to the present invention.

FIG. 2 is a cut-away perspective view schematically showing the vessel dilation device for distal body parts according to the present invention.

FIG. 3 is an exploded perspective view schematically showing the vessel dilation device for distal body parts according to the present invention.

FIGS. 4 and 5 are sectional views schematically showing the vessel dilation device for distal body parts according to the present invention.

### BEST MODE

The present invention, as the best mode for embodiments, provides a vessel dilation device for distal body parts, which includes: a main body formed therein with a first accommodation space into which a distal body part (hand, foot or penis) is inserted, formed of a flexible material to tightly encompass the distal body part inserted toward a closed one side portion thereof, and formed in a side surface thereof with a plurality of micro cut holes; and a housing formed therein with a second accommodation space into which the main body is inserted and mounted, and formed at one end portion thereof with a suction hole for allowing a decompressor to be separably connected, in which air in the second accommodation space is sucked by the decompressor, thereby being induced into a vacuum state, wherein the body includes a plurality of prevention protrusions protruding from the outer circumferential surface thereof in a circumferential direction or in a direction from the one side to the other side to prevent the micro cut holes from being excessively expanded when the second accommodation space is decompressed through the decompressor.

### Mode for Invention

Hereinafter, configurations and operations for specific s of the present invention will be described in detail reference to the accompanying drawings.

Herein, it will be noted that the same elements have the same number as possible in adding reference numerals for elements in the drawings even if the elements are indicated on different drawings.

Further, in the following description of the embodiments of the present invention, the detailed description of relevant known functions or configurations will be omitted not to make the subject matter of the present invention unclear.

In addition, when one component “includes” some elements, it does not exclude other elements, but may further include the other elements, unless particularly stated otherwise.

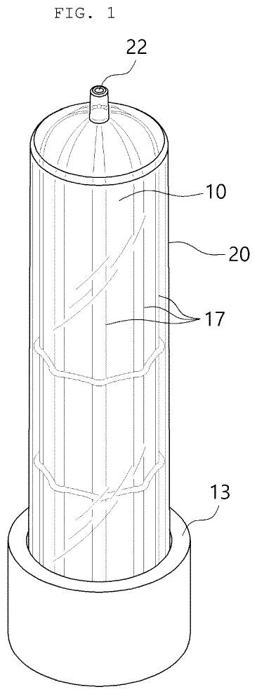

In addition, in the following description of the embodiments of the present invention, one side refers to a side or portion thereof in which a suction hole is formed with reference to FIG. 1, and the other side (opposite side) refers to a side or portion thereof opposite to the one side in which a fitting cap is formed. In addition, the expression ‘inside’ refers to each component or an inner direction divided by each component or a section in the direction, and the expression ‘outside’ refers to a section in an opposite direction of the expression ‘inside’ or an area in the opposite direction.

As shown in the drawings, the vessel dilation device for distal body parts according to the present invention is configured to promote the dilation of blood vessels of the distal body parts (hands, feet or penis) during use thereof so as to make the blood flow smoothly, thereby improving blood circulation function and increasing physical vitality. In particular, the biggest feature is to induce expansion of the blood vessels or the corpus cavernosum penis therein while suppressing skin damage by limiting excessive skin stretching when applied to the distal body parts (hands, feet, or penis).

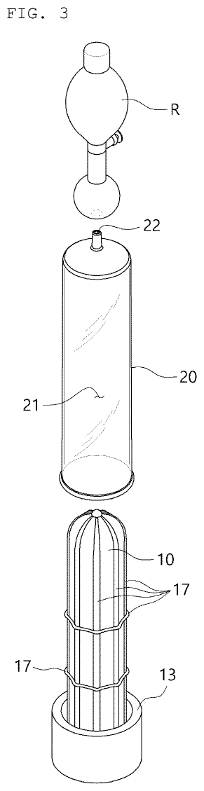

To this end, the vessel dilation device for distal body parts according to the present invention, as shown in FIGS. 1 to 5, mainly includes a main body 10 and a housing 20.

First, the main body 10 of the present invention may be formed therein with a first accommodation space 11 into which a distal body part (hand, foot or penis) is inserted, formed of a flexible material to tightly encompass the distal body part inserted toward a closed one side portion thereof, and formed in a side surface thereof with a plurality of micro cut holes 12.

For example, the main body 10 has a shape similar to a cylinder and may be formed of a material having flexibility and elasticity such as silicone, rubber or latex.

In addition, the main body 10 may have a predetermined size and shape to correspond to the distal body part such as the hand, foot or penis.

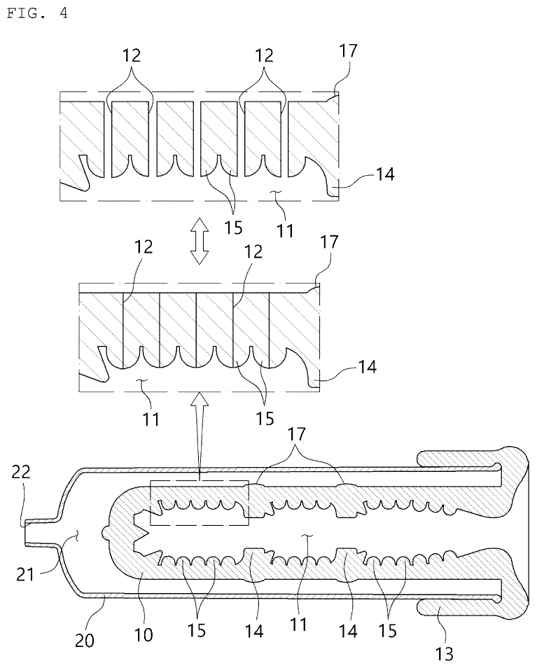

As shown in FIG. 4, the above-described micro cut holes 12 may be slightly expanded when a second accommodation space 21 is decompressed through a decompressor R described later.

Accordingly, air may be properly circulated within the device when decompressed through the decompressor R described later, so that only the blood vessels or the corpus cavernosum penis may be expanded while the skin of the distal body part inserted into the above-described first accommodation space 11 is suppressed from excessively inflating like a normal balloon, thereby achieving smooth blood supply and blood circulation in the distal body part.

For example, when a high vacuum pressure is applied through the decompressor R described later, an outer circumferential surface of the main body 10 comes into close contact with an inner circumferential surface of the housing in a shape similar to surface contact, and an inner circumferential surface of the main body 10 pressurizes the skin at the distal body part so as to induce expansion of the blood vessels or the corpus cavernosum penis.

This is because, when the outer circumferential surface of the main body 10 and the inner circumferential surface of the housing 20 fail to come into close contact with each other during the above-mentioned decompression process, the skin at the distal body part may be damaged without inducing pure expansion of the blood vessels or the corpus cavernosum penis at the distal body part.

In addition, the main body 10 may be provided with a fitting cap 13 bent along an outer circumference of the other side portion into which the distal body part is inserted, and extending to one side.

Accordingly, the other end of the housing 20 described later is inserted mounted and between the outer circumferential surface of the other end of the main body 10 formed of a material having flexibility and elasticity, and the inner circumferential surface of the fitting cap 13 so as to come into close contact (pressure) with each other, thereby increasing a coupling force, so that stable use of the device may be induced.

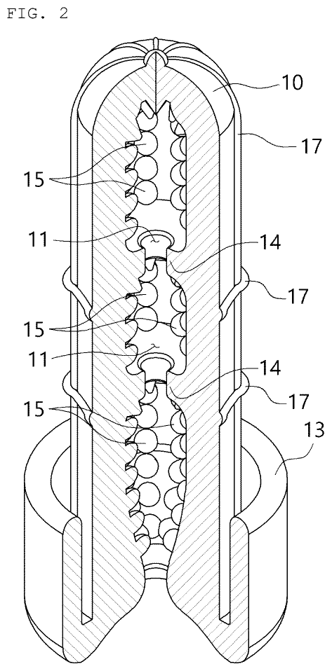

It is desirable that the other end of the main body 10, that is, an entrance through which the distal body part is inserted may be configured to have a gently curved shape to correspond to the distal body part, so that the distal body part is allowed to be naturally sucked into the first accommodation space 11 by the decompression through the decompressor R described later, thereby achieving convenient use (see FIGS. 2 and 4).

For example, before the distal body part is inserted into the above-described first accommodation space 11, a normal gel may be applied to ensure smoothness in use.

In addition, since the main body 10 of the present invention is formed of the elastic material, blood may be prevented from flowing only to the epidermis of the skin due to the structure of the distal body part and simultaneously the epidermis of the skin may be strongly held when the vacuum pressure is applied, so that the pure expansion of only the blood vessels at the distal body part or only the corpus cavernosum penis may be induced.

Regarding the degree of elasticity of the main body 10, the main body 10 formed of a hard material having a low degree of elasticity may fail to induce the expansion of the distal body part when the vacuum pressure is applied. On the contrary, when the degree of elasticity is too excessive and the vacuum pressure is applied, only the skin at the distal body part may be stretched or the blood vessels or corpus cavernosum penis may be rapidly expanded, thereby causing damage such as wounds.

Further, the main body 10, as shown in FIGS. 2, 4 and 5, may be configured to include one or more annular support protrusions 14 protruding along the inner circumferential surface thereof to closely contact and support the distal body part inserted into the above-described first accommodation space 11.

In addition, the main body may be configured to include a plurality of stimulation protrusions 15 protruding from the inner circumferential surface thereof, other than the above-described support protrusions 14, to closely contact the distal body part inserted into the first accommodation space 11, thereby stimulating the skin at the distal body part when the second accommodation space 21 is decompressed through the decompressor R described later.

Further, the main body may be configured to include a plurality of prevention protrusions 17 protruding from the outer circumferential surface thereof in a circumferential direction or in a direction from the one side to the other side to prevent the micro cut holes 12 from being excessively expanded when the second accommodation space 21 is decompressed through the above-described decompressor R.

Accordingly, when the blood vessels of the distal body part inserted into the first accommodation space 11 is expanded due to a negative pressure through the decompressor R described later, the distal body part may be pressurized or stimulated through the support protrusions 14 and the stimulation protrusions 15, and the support protrusions 14 and the stimulation protrusion 15 may perform a gentle massage function on the distal body part, thereby serving as a factor for allowing the blood vessels or the corpus cavernosum penis inside the skin to expand more stably and efficiently.

In particular, the blood is more supplied to the distal body part through the configuration of the support protrusions 14 and the stimulation protrusions 15, that is, the support protrusions 14 and the stimulation protrusions 15 provide stimulation to the distal body part. This is because the blood is allowed to be easily concentrated in the blood vessels or the corpus cavernosum penis at the distal body part before vacuum pressure is applied, thereby inducing the blood to naturally collect other than forcibly flow thereto, so that safe and efficient use may be realized.

In addition, a proper thickness between the outer circumferential surface and the inner circumferential surface of the main body 10 may be ensured through the configuration of the outer prevention protrusions 17 together with the support protrusions 14 and the stimulation protrusions 15 described above, thereby serving to prevent the micro cut holes 12 from expanding excessively when the negative pressure is applied, so that excessive skin expansion may be blocked at the distal body part to prevent skin damage.

As shown in FIGS. 1 and 3 to 5, the housing 20 of the present invention may be formed therein with a second accommodation space 21 into which the main body 10 is inserted and mounted, and be formed at one end portion thereof with a suction hole 22 for allowing a decompressor R to be separably connected, in which air in the second accommodation space 21 is sucked by the decompressor R, thereby being induced into a vacuum state.

When the above-described vacuum state in the second accommodation space 21 is induced in the above manner, the blood vessels or the corpus cavernosum penis at the distal body part may be expanded by the above-described negative pressure.

As described above, the housing 20 may have the other end mounted and fitted between the outer circumferential surface of the other end of the main body 10 and the inner circumferential surface of the fitting cap 13 to come into close contact (pressure) with the main body 10.

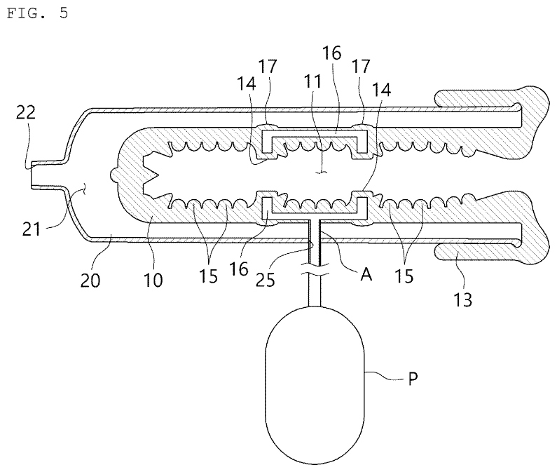

Meanwhile, in another example, in the vessel dilation device for distal body parts according to the present invention as shown in FIG. 5, the above-described main body 10 may further include an elastic rod 16 formed between the inner and outer circumferential surfaces thereof to induce elasticity (extension or contraction) of the support protrusions 14 as well as the stimulation protrusions 15 according to injection or suction of air.

The housing 20 may be further formed with an insertion hole 25 into which an air tube A is inserted so as to be mounted to an inlet side of the elastic rod 16, and the air tube A may be connected to an air pump P.

The elastic rod 16, when being formed the main body 10, may be preferably excluded in the section formed with the micro cut holes 12, and may be formed in some or entire portions of the main body 10 as needed.

Accordingly, the expansion and contraction of the support protrusions 14 as well as the stimulation protrusions 15 are induced and controlled, thereby repeatedly applying and releasing appropriate stimulation to the distal body part in the process of use, so that the expansion of blood vessels or corpus cavernosum penis and the blood circulation can be facilitated.

For example, the air pump P may enable a user to manually inject or release air, and the air pump P equipped with a timer may be applied to automatically repeat the injection and release of air.

The present invention has been shown and described with reference to specific embodiments, however the present invention is not limited to the above-described embodiments, and various changes and modifications can be made without departing from the technical idea of the present invention.

1. A vessel dilation device for a distal body part, the vessel dilation device comprising:
a main body formed therein with a first accommodation space into which the distal body part (hand, foot or penis) is inserted, formed of a flexible material to tightly encompass the distal body part inserted toward a closed one side portion thereof, and formed in a side surface thereof with a plurality of micro cut holes; and
a housing formed therein with a second accommodation space into which the main body is inserted and mounted, and formed at one end portion thereof with a suction hole for allowing a decompressor to be separably connected, in which air in the second accommodation space is sucked by the decompressor, thereby being induced into a vacuum state, wherein
the body includes a plurality of prevention protrusions protruding from an outer circumferential surface thereof in a circumferential direction or in a direction from one side to an opposite side thereof to prevent the micro cut holes from being excessively expanded when the second accommodation space is decompressed through the decompressor.

2. The vessel dilation device of claim 1, wherein the main body includes a fitting cap bent along an outer circumference of the opposite side into which the distal body part is inserted, and extending to the one side, in which an opposite end of the housing is fitted between an outer circumferential surface of an opposite end of the main body and an inner circumferential surface of the fitting cap to come into close contact with each other.

3. The vessel dilation device of claim 1, wherein the body includes:
one or more annular support protrusions protruding along an inner circumferential surface thereof to closely contact and support the distal body part inserted into the first accommodation space; and
a plurality of stimulation protrusions protruding from the inner circumferential surface thereof, other than the support protrusions, to closely contact and stimulate the distal body part inserted into the first accommodation space.

4. The vessel dilation device of claim 1, wherein the micro cut holes are slightly expanded when the second accommodation space is decompressed through the decompressor.

5. The vessel dilation device of claim 3, wherein the main body further includes an elastic rod formed between the inner and outer circumferential surfaces of the main body to induce elasticity of the support protrusions according to injection or suction of air, and
the housing further includes an insertion hole into which an air tube is inserted so as to be mounted to an inlet side of the elastic rod, in which the air tube is connected to an air pump.
